(19) United States
(12) Patent Application Publication
(10) Pub. No.: US 2001/0023777 A1
(43) Pub. Date: Sep. 27, 2001

(54) Highly dense spacer

(76) Inventors: Si-Yong Lee, Taejon (KR); Yong-Gyun No, Taejon (KR); Myung-Woo Seo, Taejon (KR)

Correspondence Address: STAAS & HALSEY LLP, 700 11TH STREET, NW, SUITE 500, WASHINGTON, DC, 20001, US

(21) Appl. No.: 09/735,796

(22) Filed: Dec. 14, 2000

(30) Foreign Application Priority Data
Mar. 27, 2000 (KR) 2000-15585

(51) Int. Cl. H02G 3/04

(52) U.S. Cl. 174/97

(57) ABSTRACT

A highly dense spacer in which multiple ducts to longitudinally accommodate a variety of cables are arranged, and which includes a spacer body having a groove for weight reducing; a binder for binding two spacer bodies through an end side of the groove on each spacer body; and a mover for moving in one way which is facilitated on the surface of a space body. Therefore, the highly dense spacer easily and stably installs a variety of cables without using distinct inner ducts.

### FIELD OF THE INVENTION

The present invention relates to a highly dense spacer; and, in more particular, to a spacer in which a variety of cables are accommodated, thereby reducing costs due to installations of duplicated ducts or conduits.

### DESCRIPTION OF THE PRIOR ART

In case of installing cables inside ducts or conduits in prior arts, methods of installing smaller ducts inside a larger duct, or methods of installing supporting frames inside of a large duct have been used. However, the methods of installing smaller ducts inside a larger duct have disadvantages such as many steps of installing processes and technical difficulties in long-distance installing processes due to duplicated duct installations. In the other hand, the methods of installing supporting frames inside of a large duct have such a disadvantage as independent supporting frames have to be installed in the large duct.

### SUMMARY OF THE INVENTION

Therefore, it is an object of the present invention to provide a highly dense spacer having multiple ducts, which tolerates under higher pressure.

It is another object to provide a highly dense spacer in which optical fibers can be easily and stably installed.

It is further another object to provide a spacer capable of accommodating a variety of cables.

In accordance with an aspect of the present invention, there is provided a highly dense spacer, comprising: a spacer body in which multiple ducts to longitudinally accommodate a variety of cables are arranged, and on whose surface longitudinally has a groove for weight reducing ; a binder for binding two spacer bodies through an end side of the groove on each spacer body; and a mover for moving in one way which is facilitated on the surface of the space body.

### BRIEF DESCRIPTION OF THE DRAWINGS

The above and other objects and features of the instant invention will become apparent from the following description of preferred embodiments taken in conjunction with the accompanying drawings, in which:

FIG. 1 is a perspective view of the first example of the present invention depicting two assembled highly dense and multi-ducted spacers in decomposition;

FIG. 2 is an elevation view showing a highly dense spacer in an installed state;

FIG. 3 is a schematic view showing a highly dense spacer which has a slide-preventing device and one-way mover;

FIG. 4 is a perspective view depicting in detail a slide-preventing device for a highly dense spacer;

FIG. 5 is a perspective view depicting in detail an one-way mover for a highly dense spacer;

FIG. 6 is a perspective view showing the second example of a highly dense spacer which is referred to as a “weight-reduced circular spacer”;

FIG. 7 is an elevation view showing a weight-reduced circular spacer of FIG. 6;

FIG. 8 is a perspective view showing the third example of a highly dense spacer in which a variety of cables such as copper wires and optical fibers can be accommodated;

FIG. 9 is an elevation view showing in an installed state in the larger duct of a highly dense spacer of FIG. 8;

FIG. 10 is a perspective view showing the fourth example of a highly dense spacer in which octagonal ducts are arranged;

FIG. 11 is a cross-sectional view of a highly dense spacer of FIG. 10;

FIG. 12 is a perspective view showing the fifth example of a highly dense spacer through which optical fibers can be pulled over; and

FIG. 13 is a cross-sectional view of a spacer having a high density and multiple ducts of FIG. 12.

### DETAILED DESCRIPTION OF THE PREFERRED EMBODIMENTS

Hereinafter, preferred embodiments of the present invention will be described in detail with reference to the accompanying drawings.

A highly dense spacer according to the present invention easily and stably install a variety of cables without using distinct inner ducts.

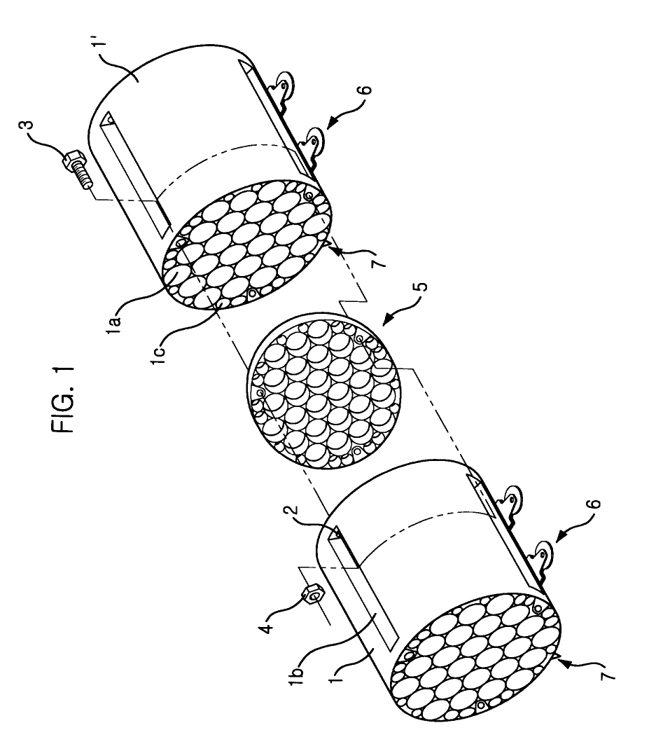

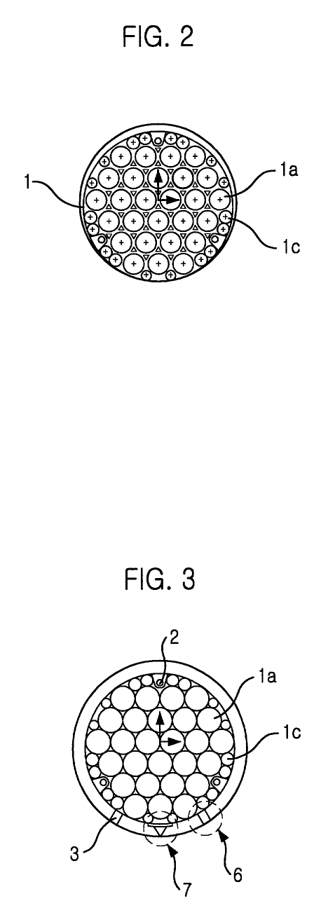

Referring to FIGS. 1 and 2, the highly dense spacer in accordance with the present invention includes a space body 1 having a groove 1b for reducing the weight and combining two bodies 1 and 1′ by bolting, and has multiple large ducts 1a in the space body 1 in order to longitudinally accommodate a variety of cables. Multiple small ducts 1c are located outer of the multiple large ducts 1a.

A binding hole 2 is located at a side of a groove for weight reducing 1b. In case a longer spacer is needed, spacer bodies are continuously connected up to a needed length. FIG. 1 shows a method in which two spacer bodies 1 and 1′ are connected by a bolt 3 and a nut 4. Furthermore, a gasket 5 which has the same structure as the two spacers can be inserted between the two space bodies 1 and 1′ for the blowing method for installing optical fibers. In case of installing optical fibers in multiple large ducts 1a and multiple small ducts 1c, the gasket 5 has a sealing function for preventing air leakage between the two spacer bodies 1 and 1′, so, by the sealing function of the gasket 5, optical fibers can be easily entered into the multiple large ducts 1a. Additionally, a mover 6 in one way and a slide-preventing device 7 for preventing a spacer from sliding on an inclined surface are facilitated on the spacer bodies 1 and 1′.

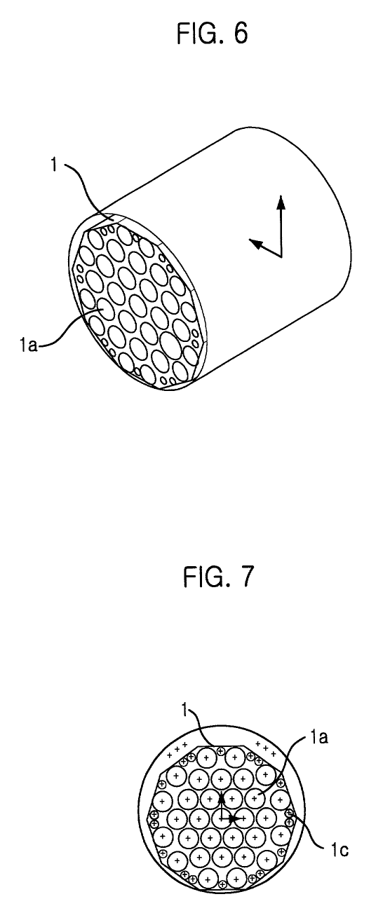

Referring to FIGS. 3 and 5, the mover 6 is facilitated on the spacer body 1, and consists of a roller-attaching body 11, which has two vertical moving guide holes 11a on both sides of itself; a roller 12 supported by the roller-attaching body 11, and having a saw-type wheel 13 attached along the roller own bottom surface; and a stopping roller 14 facilitated across two opposite vertical moving guide holes 11a and making the roller 12 to roll only in one way. At this time, the roller-attaching body 11 has a screw hole 11b through which a screw attaches the roller-attaching body to the spacer body 1, and the saw-type wheel 13 along the bottom circular surface of the roller 12 are in a curved and one-sided shape. This is effective for installing the bodies in the inclined slope. Therefore, the spacer body 1 can be moved clockwise in case of FIG. 6. In the other hand, if the spacer body 1 is tried to move counterclockwise, the stopping roller 14 would be stuck between the roller 12 and the saw-type wheel 13, so the spacer body 1 cannot move downwards.

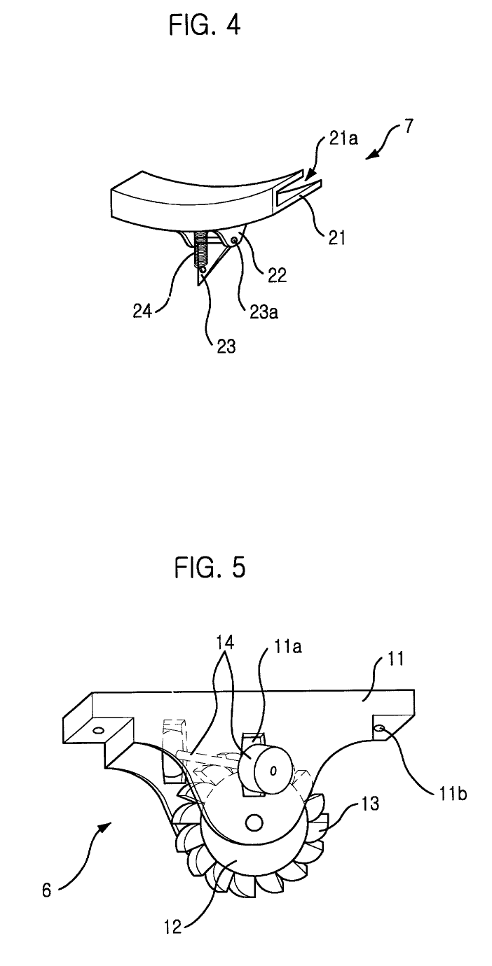

Referring to FIGS. 3 and 4, a slide-preventing device 7 includes a zig 21, two supporting panels 22, a braking needle 23 and a spring 24. The zig 21 has an inserting hole 21a of the zig 21 has a function which can insert a bottom end of a spacer body 1 within the inserting hole 21a. Two supporting panels 22 are installed under the bottom of the zig 21, and each supporting panel 22 has a hole on itself. A braking needle 23 of a cone shape possesses a hinge pin 23a installed across each hole on two opposite supporting panels 22. A spring 24 is for absorbing shock to the breaking needle 23. The upper end of the spring 24 is connected to the zig 21, and the lower end is connected to the breaking needle 23.

Therefore, if a spacer body 1 is tried to move uphill, the breaking needle 23 slides, so the spacer body 1 can be moved. However, if the spacer body 1 is tried to move downhill, the breaking needle 23 is vertically stood by the elasticity of the spring 24, so the spacer body 1 cannot be moved downwards.

In case of the mover 6 and the slide-preventing device 7, if an inclination is gentle, the mover 6, the slide-preventing device 7, and the spacer body 1 can be manufactured into one united body. So the united body of both the mover 6 and the slide-preventing device 7 can be protruded on the spacer body 1. In the other hand, the mover 6 and the slide-preventing device 7 can be united by means for binding such as a bolt, so the united body of both the mover 6 and the slide-preventing device 7 can compensate loss of material due to friction from movement of the spacer body 1.

Even though the space body 1, the large ducts 1a, and the small ducts 1c in the above-described drawings are in circle shapes, practically, their shapes are not limited in circle shapes, but may have a variety of geometric shapes.

Referring to FIGS. 6 and 7, the spacer body 1 is made to a form having a weight-reduced surface, so the surface of the space body 1 has an angled shape. Therefore, the amount of the material for making the space body 1 is reduced, and the manufacturing process becomes easier. Additionally, the arrangement of the ducts 1a, 1c also can be performed in many different ways.

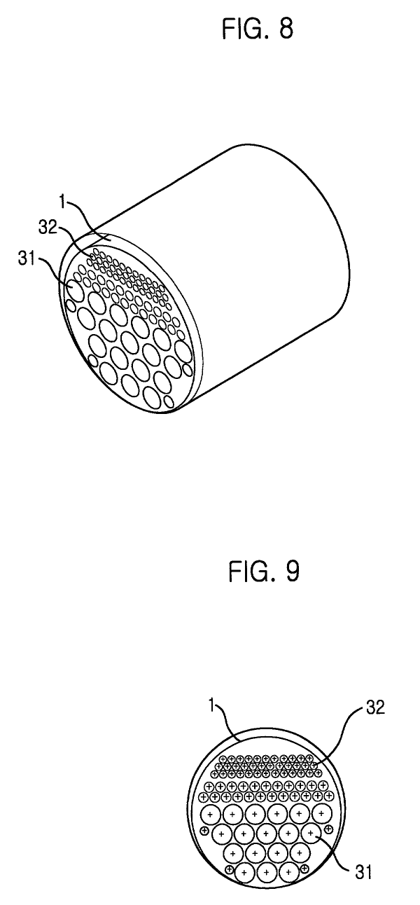

Referring to FIGS. 8 and 9, large circular ducts 31 are arranged in the lower part of a spacer, and small circular ducts 32 are arranged in the upper part of the spacer.

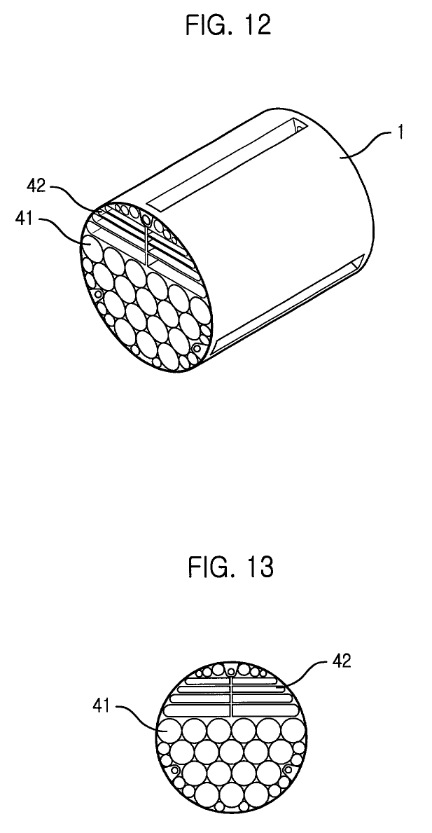

Referring to FIGS. 12 and 13, circular ducts 41 are arranged in the lower part of a spacer, and ducts for pulling optical fibers 42 are arranged in the upper part of the spacer. The ducts for pulling optical fibers 42 have horizontally long holes, and, through the ducts, optical fibers are pulled over.

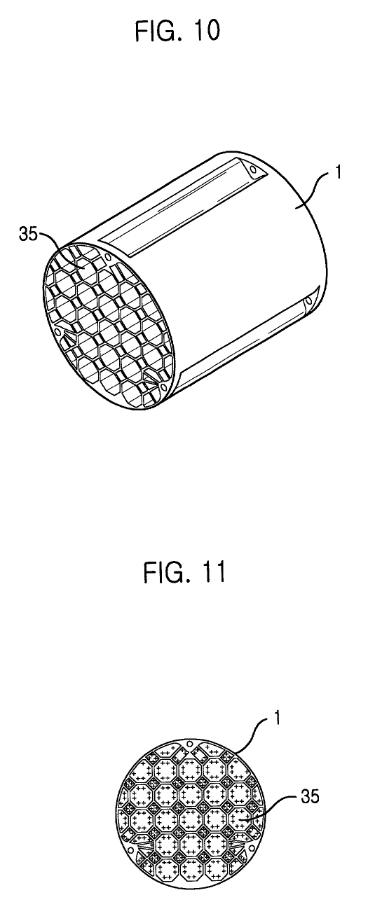

Furthermore, ducts in a spacer can be formed in a variety of shapes. For example, in reference with FIG. 10 and FIG. 11, the ducts having octagonal sections 35 are formed. The ducts having octagonal sections 35 increase space efficiency than circular ducts, and make arrangement of optical fibers and finding locations of optical fibers easier.

Although the preferred embodiments of the invention have been disclosed for illustrative purpose, those skilled in the art will be appreciate that various modifications, additions and substitutions are possible, without departing from the scope and spirit of the invention as disclosed in the accompanying claims.

What is claimed is:

1. A highly dense spacer, comprising:
a spacer body in which multiple ducts to longitudinally accommodate a variety of cables are arranged, and on whose surface longitudinally has a groove for weight reducing;
means for binding two spacer bodies through an end side of the groove on each spacer body; and
means for moving in one way which is facilitated on the surface of the space body.

2. The spacer as recited in claim 1, wherein the multiple ducts are in a circle shape.

3. The spacer as recited in claim 1, wherein the multiple ducts are in an octagonal shape.

4. The spacer as recited in claim 1, wherein the spacer body is in a polygonal shape.

5. The spacer as recited in claim 1, further comprising a gasket that is inserted between the two space bodies in order to make possible using a blowing method for installing optical fibers.

6. The spacer as recited in claim 5, wherein the means for binding is a binding device having a bolt and a nut.

7. The spacer as recited in claim 5, wherein the means for moving includes:
a roller-attaching body which has two vertical moving guide holes on both sides of the roller-attaching body;
a roller which is supported by the roller-attaching body and has rolling guides attached along the roller own bottom surface; and
a stopper which is facilitated across two opposite vertical moving guide holes, and makes the roller to roll only in one way, preventing the roller from rolling in the other way.

8. The spacer as recited in claim 5, further including:
a zig which inserts a bottom end of the spacer body within the zig own inserting hole;
a braking needle which is installed under the bottom of the zig; and
a spring whose upper end is connected to the zig, whose lower end is connected to the breaking needle, and which absorbs shock to the breaking needle.
